(19) United States
(12) Patent Application Publication
(10) Pub. No.: US 2015/0142175 A1
(43) Pub. Date: May 21, 2015

(54) MACHINE COMPONENT OF A DRIVETRAIN AND A METHOD FOR CONFIGURING AND/OR PUTTING INTO OPERATION AND/OR OPERATING SUCH A DRIVETRAIN

(71) Applicant: SIEMENS AKTIENGESELLSCHAFT, München (DE)

(72) Inventors: Jan-Dirk Reimers, Aachen (DE); Arno Klein-Hitpass, Aachen (DE); Ralf Martin Dinter, Gelsenkirchen (DE)

(73) Assignee: SIEMENS AKTIENGESELLSCHAFT, München (DE)

(21) Appl. No.: 14/407,826

(22) PCT Filed: Jun. 11, 2013
(86) PCT No.: PCT/EP2013/061943

§ 371 Date: Dec. 12, 2014

(30) Foreign Application Priority Data
Jun. 15, 2012 (EP) 12172185.6

(51) Int. Cl. B60W 30/188; G01M 13/02; G05B 15/02; G01M 13/00

(52) U.S. Cl. CPC B60W 30/188; G01M 13/00; G01M 13/022; G01M 13/02; G05B 15/02
USPC 700/275

(57) ABSTRACT

The invention relates to a machine component of a drive train and to a method for configuring and/or putting into operation and/or operating such a drive train (2) of a machine (1), which drive train comprises machine components that can be controlled by means of a control unit (9) as well as non-controllable machine components (5-8), wherein the method comprises the steps of: equipping at least a portion of the non-controllable machine components (5-8) with component-specific data storage devices (12-15), on which in each case design-related technical data of the non-controllable machine components (5-8) are stored, which data are relevant for the control of one or several controllable machine components (3-4); transmitting the data stored on the data storage devices (12-15) to the control unit (9); and controlling one or more controllable machine components (3, 4) by using the control unit (9) and on the basis of the data transmitted.

The present invention relates to a method for configuring and/or putting into operation and/or operating a drivetrain of a machine, which drivetrain has controllable machine components and non-controllable machine components and is connected to a control unit, as well as to a machine component of a drivetrain.

The configuration, the putting into operation and ultimately also the operation of drivetrains of relatively large machines such as, for example, energy-generating machines operating like a generator or heating machines, force machines and working machines, always include as a technical requirement the step of synthesizing the individual components of the corresponding drivetrain.

Essential components of a drivetrain are, for example, the engine, engine clutch, brake system, toothed-wheel transmission, drive shafts, drive bearings, frequency converters etc. They normally originate from various engineering disciplines and can have a high degree of integration in special machines. Alternatively, they are combined to form modules with defined interfaces and are assembled according to requirements for different applications.

In order to achieve a relatively high level of automation, in relatively complex applications it may be necessary to integrate the drivetrain of a machine into further machine processes. In conveyor belt systems, it is desirable, for example, to perform integration into the superordinate conveyor system, and in wind power plants to perform integration into the wind park control system, etc.

Furthermore, it is necessary to integrate the acquisition of operating data. The acquisition of operating data is divided into technical operating data and organizational operating data. The technical operating data is often described by the term SCADA system (Supervisory Control and Data Acquisition System). This includes the monitoring and controlling of technical processes by means of a computer system. The organizational operating data is often associated with the term PPS system (Production Planning and Control System). This is a computer program or a system composed of computer programs which supports the user during production planning and production control and performs the data management associated therewith. The objective of a PPS system is to implement short run-through times, to keep to deadlines, to achieve optimum levels of stocks, to ensure economical use of operating means, etc. Both operating data acquisition approaches can be implemented within one machine structure which can be built up in either a centralized or decentralized fashion.

In particular in the case of machine applications which have to be operated without monitoring by employees or without possibilities of rapid accessibility or else in the case of machines which take part in processes which involve a high level of danger or are economically important, the availability of the operational capability of the machine is highly significant. In these machines, CMS systems (Condition Monitoring Systems) are additionally used which have the function of performing state monitoring, or furthermore also CDS systems (Condition Diagnostic Systems) which have the function of performing state monitoring including error diagnosis. By means of these CMS/CDS systems, the operational control of the machine is to be protected against entering unforeseen damaging states which lead to failure of the machine. The damage which occurs is to be signaled in good time so that repairs can be planned in good time.

A generally recognized conception is that by detecting damage a control unit can be enabled to prolong the time period up to the ultimate failure of the machine through a changed controlled process of the controllable machine components, or that a prolonged operating time of the machine can be achieved through operational control and regulator actuation of the machine which are modified in advance. The objective of the corresponding application is to avoid failures and increase the service life of the machine.

For this purpose, a machine must be equipped with significantly more sensors than it merely would be for the operational control or the operating data acquisition. Furthermore, the sensor information of the extended operating data acquisition has to be evaluated. During the selection of the sensors, all the involved machine components must ultimately be taken into account within the scope of a risk analysis. These machine components can include, at least, the force-conducting elements such as, for example, shafts, bearings, transmissions, motors, power inverters and the power supply, but also subsystems such as the cooling system, lubricating oil supply and control devices.

The monitoring sensors are ultimately also the operationally relevant systems and their operational capability must also be monitored. All the information structures of machines which are known today can be categorized within the scope of this information triangle composed of PPS, SCADA and CMS-CDS.

In order to ensure satisfactory operation of a machine, it is therefore necessary for a machine structure which is functionally capable throughout all the machine component boundaries to be produced. The interactions between the machine components must be completely combined for the safe operational control and taken into account in accordance with the control which is then to be configured later. For this purpose, until now, a simulation of the system has been considered to be beneficial, said simulation being carried out in advance alongside the development work and presenting a mechanical engineer with new problems which take up a very large amount of time and money. The design of a machine system takes place in two stages. Firstly, the reference values of the power variables are adjusted to one another and then combined by means of the machine components to form a system which then has to meet system properties within the dynamic operational control and within the scope of a power curve of the applicational requirement. An open-loop and/or closed-loop control configuration in which the information paths for the operating data acquisition are defined then takes place. In addition to the external requirements of the application which predefine the operational control and which are then to be achieved in the operational control by the closed-loop and open-loop control variables, there are internal interactions between the machine components which also have to be taken into account.

There is then the problem that these interactions have to be taken into account continuously for all the operationally relevant requirements, but nowadays this can only be done within the structure of the sourcing of the machine components by means of formulated specification schedules. This undertaking is becoming increasingly complex and requires a high degree of expenditure and, a high knowledge level of individual effects from the individual technical disciplines of machine engineering and electrical engineering, automatic control engineering, damage diagnosis, etc., in order to be able to take into account the system behavior for a machine controller including damage diagnosis and suppression of damage. A large portion of the work here is taken up with the assessment of the oscillation excitation. By way of example, the air gap moments of the motors, the tooth engagement impacts of the transmission stages, the effect of the mechanical brakes, external loads which act on the machine, etc., influence the dynamic behavior of the oscillation system of the drivetrain as excitation functions.

The most important measure for reducing the oscillation in general is to reduce the exciter forces which, however, have to be known for all the components. All further measures for reducing oscillation are then appropriate only if the cause of the oscillations, that is to say the excitation, has been largely reduced in advance. During the reduction of the exciter forces, a differentiation is made between the prevention and the compensation of the exciter forces. The measures for preventing the exciter forces include, for example, balancing by mass equalization. With this method, only exciter components which have synchronous rotational speeds can be minimized owing to the mass imbalance. In the case of tooth intervention frequencies in transmissions, for example helical gearing and suitable tooth corrections can bring about a reduction. Pole change frequencies of electric machines can also be reduced with current controllers or mechanically obliquely positioned grooves. The power inverter can be equipped with special filters. Compensation of the exciter forces can be understood to mean active methods for excitation compensation by applying force to the component. With this method, which can also be considered to be active oscillation control, it is also possible to compensate non-synchronous excitation components.

The reduction of the oscillation by changing system properties, which is also referred to as detuning, can be achieved, for example, by changing bearing stiffness values or the external damping. Here, it is also possible to use clutches between the machine components such as, for example, elastomer bearings, passive or active hydraulic elastomer bearings or the like. Since an optimum reduction in oscillation for the entire operational rotational speed range generally requires adaptation of the stiffness properties or damping properties, recently research has been carried out in particular in active or semi-active methods which permit such an adaptation capability. The passive methods of detuning include the widespread method of increasing the bearing damping by using squeeze oil dampers. The oscillation behavior can be considerably improved in critical resonances by means of additional dynamic systems whose natural frequency is matched to a critical natural frequency of the machine system. However, this requires these resonances to be known over all the systems, which gives rise to considerable expenditure during the initial configuration and the later exchange of components.

Against this background, an object of the present invention is to make available a method of the type mentioned at the beginning in which synthesization of machine components of the drivetrain and therefore the actuation or regulation of the controllable machine component in order to achieve satisfactory machine operation and integration of the drivetrain into a superordinate system and/or into a PPS, SCADA, CMS and/or CDS system can take place in a simple and at least partially automated fashion.

In order to achieve this object, the present invention provides a method of the type mentioned at the beginning which has the steps: equipping at least some of the non-controllable machine components with component-specific data memories, in each of which design-related technical data of the non-controllable machine components is stored, which technical data is relevant for the control of one or more controllable machine components; transferring the data stored in the data memories to the control unit, and controlling one or more controllable machine components using the control unit and taking into account the transferred data.

On the basis of the now increasingly customary equipping of individual machine components with sensors or CMS units, such as, for example, with a bearing monitoring system, a transmission diagnostic unit or a simple RFID chip for better component detection in the case of servicing, it is surprisingly easily possible according to the invention to store a data set for each non-controllable machine component, which data set permits, within the operational control and within the scope of operation data acquisition which is subsequently expanded, basically automatic parameterization of the controllable (active) machine components in the sense of the non-controllable (passive) machine components. The reference data which are provided structurally in any case for the passive machine components are stored, according to the invention, in a component-specific data memory and can then be passed onto the control unit, or read out therefrom, during the assembly of the drivetrain, and can subsequently be taken into account by this control unit during the parameterization or actuation of the active machine components. In this context, a suitable data management system can be used, such as, for example, a bus system, CAN, I²C, Ethernet, RS232 or the like, as well as RFID or other reading formats. This results in a very precise, at least partially automated synthesis taking into account the design-related technical data of the passive machine components. A further advantage is that individual passive machine components can also be exchanged without this resulting in large expenditure on the renewed synthesis of the machine components.

In the method, at least some of the controllable machine components are also preferably equipped with component-specific data memories, in each of which at least one parameterization region is stored, within the limits of which the corresponding controllable machine component can be controlled, wherein the data stored in the data memories of the controllable machine components is transferred to the control unit, and the controllable machine components are controlled taking into account this data. Accordingly, the data of all the machine components which are to be synthesized can be made available automatically to the control unit for further use.

Limiting temperatures and/or limiting rotational speeds and/or limiting power levels and/or moments of inertia and/or spring stiffness values and/or damping constants and/or load dwell time curves (LDD) and/or RFC matrices (Rain Flow Count Matrices) and/or Campbell diagrams and/or coefficients of safety values of a machine component are preferably stored as design-related technical data, which will be explained individually in more detail below.

According to one refinement of the method according to the invention, at least one sensor which detects actual values of a machine component is used, wherein closed-loop control of at least one controllable machine component is carried out taking into account the actual values which are detected by the at least one sensor. With sensors it is possible to implement automatic state monitoring and fault diagnosis (CMS/CDS) which is based on monitoring data.

The actual values which are detected by the at least one sensor and the technical data which is stored in the data memories are advantageously stored for analysis purposes, in particular for determining the utilization factor of the machine and/or of individual machine components and/or for further processing in a CMS/CDS system.

In addition, the number of times the load of individual machine components is exceeded is preferably detected, stored and evaluated.

According to one refinement of the present invention, one of the non-controllable machine components is a transmission, wherein, tooth engagement frequencies and/or rollover frequencies and/or the tooth edge play and/or the rotational tooth edge play are/is preferably stored in the data memory of the transmission as design-related technical data.

In addition, the present invention provides, for the solution of the object stated at the outset, a machine component of a drivetrain, which machine component cannot be controlled by means of a control unit, that is to say is a passive machine component of the type described above, and has a readable data memory in which design-related technical data of the machine component which is relevant for the control of a controllable machine component of a drivetrain of a machine is stored.

The machine component is preferably a transmission, a bearing, a clutch or a brake.

Limiting temperatures and/or limiting rotational speeds and/or limiting power levels and/of moments of inertia and/or spring stiffness values and/or damping constants and/or load dwell time curves (LDD) and/or RFC matrices and/or Campbell diagrams and/or coefficients of safety values of a machine component are advantageously stored in the data memory as design-related technical data.

The present invention will be explained in more detail below on the basis of an exemplary embodiment with reference to the appended drawing, in which:

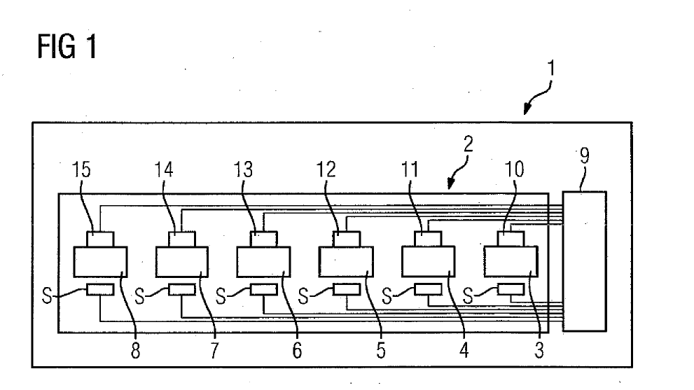

FIG. 1 shows a schematic illustration of a machine according to an embodiment of the present invention;

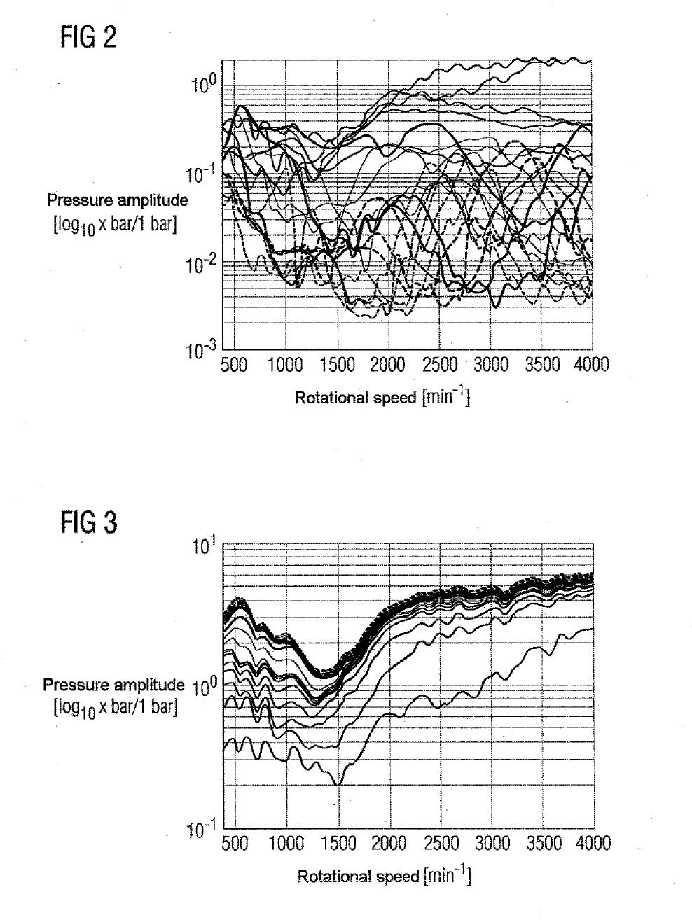

FIG. 2 shows a diagram which shows the order sequence for the orders 1 to 20; and

FIG. 3 shows a further diagram which shows the cumulated sum for illustrating the order sequence.

The machine 1, which may be any desired machine, has a drivetrain 2 by means of which an end effector (not illustrated in any more detail), for example in the form of cement mill, a belt drive, a grinding system, a roller, a press, a conveyor belt or the like, can be driven. The drivetrain 2 comprises a plurality of machine components 3-8 which are composed of individual machine elements or modules. The machine components 3 and 4 are active machine components which can be controlled by means of a control unit 9 such as, for example, an electric machine, a power inverter or the like, to name only a few examples. The machine components 5-8 are non-controllable passive machine components, for example in the form of a bearing, a transmission, a clutch, a brake, etc.

In addition, the drivetrain 2 comprises a plurality of sensors S which monitor predetermined parameters of the machine components 3-8 and transfer them to the control unit 9 for the purpose of evaluation.

In contrast to conventional drivetrains, each machine component 3-8 of the drivetrain 2 according to the invention is provided with a component-specific data memory 10-15 in which technical data of the respective machine component 3-8 is stored, which data can be transferred to the control unit 9. This data comprises, for example, limiting temperatures and/or limiting rotational speeds and/or limiting power levels and/or moments of inertia and/or spring stiffness values and/or damping constants and/or load dwell time curves (LDD) and/or RFC matrices and/or Campbell diagrams and/or coefficients of safety values of the respective machine components 3-8. Furthermore, by way of example, the minimum rotational speed, minimum load and limiting accelerations for a bearing, tooth engagement frequencies, tooth edge play and rotational tooth edge play for transmission, the non-uniformity of the cardan shaft for a clutch, the thermal limit and the minimum and/or maximum braking profile for a brake, the number of poles, number of pole pairs, rotor fundamental wave, rotor harmonic, stator fundamental wave, stator harmonic, number of slots, number of winding phases, number of rotor sections and number of rods for an electric machine, and the clock frequency, switching edges, harmonic, oscillation, transmission function, cut-off frequencies for an inverter, for example of filters etc. are stored as design-related technical data in the associated data memory, and this enumeration should not be considered conclusive here. In addition, the parameterization ranges within the limits of which the respective machine component 3 and 4 can be controlled are stored in the data memories of the active machine components 3 and 4.

After the transfer of this data to the control unit 9, the latter can parameterize the active machine components 3 and 4 in a fully or partially automated fashion while taking into account the demand profiles of all the machine components 3-8 of the drivetrain 2, thus making it possible to ensure that the configuration, putting into operation and operation of the drivetrain 2 are satisfactory. Furthermore, of course, the limits of those parameters of the individual machine components 3-8 which are monitored by the sensors S are also transferred to the control unit 9, with the result that a complicated setting up of the corresponding CMS/CDS system is not necessary here either. A further advantage is that individual machine components 3-8 or parts thereof can be exchanged without difficulty. The component-specific data of the new parts must merely be read out and transferred to the control unit 9, after which the latter automatically performs changes to the system where necessary.

The individual data items which can be stored in the component-specific data memories 10-15 will be explained below in more detail for the sake of better understanding.

The dynamic loading of the drivetrain 2 is composed basically of three parts, specifically of the technological loads which can vary over time, the kinetostatic loads from the rigid body movements (primary movements) and the vibrodyamic loads from the oscillations of the structure (secondary movements).

The data which is stored according to the invention in the data memories 10-15 of the individual machine components 3-8 comprises the structural reference values from the technological loads which can vary over time and the kinetostatic loads from the rigid body movements which are to be understood as being fixed data items of the individual machine components 3-8, but, furthermore, preferably also relevant data such as coefficients of safety values, load dwell time curves created for the calculation of operational stability, Rain Flow Count matrices, Campbell diagrams or the like. The control unit 9 can keep the three groups of the abovementioned dynamic loads below the critical limiting values by corresponding parameterization of the active machine components 3 and 4 only by means of this component-specific technical data.

In addition, the power level limits, rotational speed limits, torque limits and force flux limits have to be taken into account for all the machine components 3-8. In the case of the active machine components 3 and 4 (electric machine and power inverter), these limits are additionally reflected in the current, in the voltage position, in the phase position or in the switching frequency. These also have to be taken into account. The thermal limit owing to the power flow may be different for each of the machine components 3-8, which limits can be reached in different operating states. The respective limiting variable of a data class ultimately limits the operational control in the control unit 9. According to the invention, the machine component 3-8 which is thermally loaded the most is therefore considered to be power-limiting for the entire drivetrain 2 without this having to be explicitly parameterized in the control unit 9, since the data stored in the data memories 10-15 is easily transferred to the control unit 9.

The oscillation behavior and noise behavior (secondary movement) are a possible further system level which can also be considered to be strongly influenced by the individual machine components 3-8 and which can be excited as a function of the operating conditions or of the rotational speed.

The mechanical structures of the machine components 3-8 basically oscillate at their natural frequencies. The mechanical structure utilizes only those portions from the spectrum of the exciting frequencies which also correspond to natural frequencies of the respective structure. These portions can be applied in an unanticipated fashion over multiple components without previous exchange of data or previous simulation. Furthermore, electromechanical effects can occur as a cause of the oscillation in mechanical components. For example, the clock rate of a power inverter can be reflected in a natural oscillation of a machine component 3-8. In the case of rotating machines this can be particularly well clarified by means of a socalled Campbell diagram or spectrogram in which the orders of rotational speed of, for example, the wave according to the rotational speed are plotted against the frequency modes of the components. Points of intersection can, but do not have to, bring about a resonance since, for example, the damping is not taken into account.

There are multiple possible ways of examining the oscillation behavior of systems and structures in terms of measurement technology. In particular, it is known to perform excitation using an impulse (hammer blow) or a harmonic oscillation (sine). The latter variant can also be carried out with a frequency which varies over time as an excitation signal (sine-sweep/chirp). If the exciter frequency and natural frequency of the system coincide, the system responds with an increase in amplitude. In the case of the system comprising a gearwheel and shaft, the excitation during operation then comes from the system component of the transmission itself. As a result of the tooth engagement frequency, the system component of the shaft or housing is made to oscillate. If an FFT (Fast Fourier Transformation) which shifts chronologically is then carried out with a relatively small time window for the individual machine component 3-8, a frequency spectrum is obtained at every point and is plotted on the X axis of a diagram. The average rotational speed during the FFT window is plotted on the Y axis. The amplitude of the signal serves as the Z axis, wherein a 3D representation is usually dispensed with and the amplitude is depicted in a color-coded fashion. As a result, a structure also appears owing to the real system measurement: the zero point beams are the rotational speed harmonics, perpendicular lines are the system natural frequencies, curved lines are a sign of nonlinearities or time invariances with respect to the theoretical embodiment of the Campbell diagram. At points where system natural frequencies and rotational speed harmonics intersect, there are significant resonance effects, to which the system responds with a large amplitude.

Taking the real Campbell diagram as a basis, order tracking can easily be derived. For this purpose, a running index is allowed to run along the order beams, and the amplitudes which occur in that context are noted, separately for each order. The resulting representation is shown by FIG. 2, wherein the color coding is not represented. The first to 20th order are considered here.

This order tracking can now be cumulated. As is shown in FIG. 2, the large number of relevant orders makes the customary simultaneous representation of the orders very unclear. This can be reduced by representing the cumulated sum of the orders. In this context, instead of the n-th order the sum of the orders 1 to n is plotted, as shown in FIG. 3, wherein the color coding is not shown here either.

The representation of the cumulated sum permits the simple comparison of a number of configurations, as when the Campbell diagram is used. In one configuration of the invention, the Campbell diagram or the cumulative sum of the orders of the corresponding machine components 3-8 is stored in each data memory 10-15. This data is also transferred automatically to the control unit 9 in which the undesired operating states are then added up for the parameterization of the operational control. The same can be done with data relating to the stiffness of the machine components 3-8 or relating to the moment of inertia thereof.

The control unit 9 therefore receives not only the data of the sensors S which relates to the operating data and/or CMS-CDS data acquisition, and which is detected by sensor within each machine component 3-8, but also at the same time the component-specific limiting values.

In this way, the parameterization of the drivetrain 2 which is of modular design is significantly simplified. In particular, the passive machine components 5-8, which in the past only had a CMS-CDS system, can, in the method according to the invention, be integrated into the machine control.

Exchanging machine components 3-8 cannot bring about erroneous overloading of changed machine components, as would be possible without the data exchange according to the invention.

The previous parameterization of CMS/CDS systems is significantly simplified if the limiting values of the parameters, monitored by the sensors S, of the machine components 3-8 are also supplied by means of the data memories 10-15.

In particular, the signatures for transmission gearings and the bearing points on transmissions and shafts are caused purely by their geometrical relationships. These can already be defined in the design of the mechanics according to known forms and made available according to the invention to the CMS/CDS system via the data memories 10-15.

Exchanging machine components 3-8, such as, for example exchanging the transmission, can be carried out without hesitation since the CMS/CDS system automatically receives the new data.

The data sets relating to exciter frequencies, such as rollover frequencies, tooth engagement frequencies, etc., can be calculated in the same way for bearings, shafts and gear systems or measured on the basis of the machine component 3-8 and stored as a data set.

Given specific configurations of the power inverter and the machine and/or at certain operating points, undesired effects can occur in the machine behavior, such as unacceptable heating of the windings and of the laminated core, alternating torques, increased generation of oscillation and sound emissions as well as shaft voltage and bearing currents.

With the exception of the shaft voltage and bearing currents, in terms of causes it is to be inferred here that these undesired effects in the machine behavior are due to harmonic phenomena of the electric machine. In simplified terms, the fundamental field of the power inverter feed can be considered for the magnetic noise generation of the electric machine. This fundamental field can be derived from the effects of the harmonics of the power inverters on a harmonic equivalent diagram of the machine. These can also be stipulated per machine component here.

In addition to the group of the direct machine component operating data and the structurally defined limiting values thereof (rotational speed, rotational speed limit, torque, maximum load, bearing temperature and bearing maximum temperature, etc.) and the indirect machine component operating data (Campbell diagram, assumed LDD, assumed RFC), specific variables for closed-loop controllers can also be stored. Here, maximum accelerations or simple sequence patterns for the machine can be stored (for example service positions, parked positions, coasting limits) which can be specific for only one machine components 3-8 and would normally have to be stored explicitly in the control unit 9.

However, since the machine components 3-8 have the sensors S and the respective data memory 10-15, the control unit 9 can, according to the invention, parameterize itself by means of the reading in of the component-specific data and it is highly simplified for a user since the user can read out the data selectively in situ.

The data items relating to the type of machine component 3-8 may be different provided they are not the basic design reference data. While the limiting rotational speeds, the limiting power level, the moments of inertia, spring stiffness values and damping constants and the assumed LDD or RFC and also, for example, a Campbell diagram or a transition function can be primarily stored for all the machine components 3-8 as a data set, there are also machine component data which can be stored exclusively for specific machine components 3-8. Examples of such data for bearings, transmissions, clutches, brakes, electric machines and power inverters have already been mentioned at the beginning, for which reason a repetition will be avoided at this point.

Moreover, accelerations (shocks), load reversal, load-reversal-related oscillation play and any exceeding of individual component limiting values can be treated as special effects to be detected by sensor.

Simplified passive and active operational control can be achieved on the basis of component-related provision of data and/or also data communication.

Active oscillation damping is generally understood to refer to methods for reducing oscillation which are based on a classic closed-circuit control loop (feedback controllers, closed-loop control). Suitable sensors and actuating elements, such as are assumed to be present here at the component level, are required for this. The actuating elements which are used can act here directly on the rotating rotor or on a bearing point, but the electric machine can also be considered to be such a bearing point. According to the invention, recourse can be made here in a highly simplified fashion to a system which is provided with the operationally critical rotational speeds or torques automatically by its machine components 3-8 and can accordingly carry out the open-loop control of the operational control on the basis of the data (passive) and additionally carry out the closed-loop control thereof (active) on the basis of the sensor values.

In one embodiment of the invention, the data memories 10-15 are composed of a computer unit which is capable of processing measured values (FPGA chip, micro controller, industrial PC) which, in addition to the storage of data, can also ensure suitable processing and storage of measured values. However, a CMS/CDS unit can also be used for the same purposes.

In a further configuration of the invention, the operating data of the sensors S and the stored data of the machine components 3-8 can be used to calculate a load sum which is specified with respect to the configuration data. The instances where limiting values are exceeded in respect of the load, torque, rotational speed or oscillation can therefore be stored. The measured LDD or RFC values relating to each individual machine component 3-8 can be calculated against the structurally specified ones. A constant measurement of the load-relevant variables is then carried out, which variables are then stored as actual data together with the initial setpoint data sets.

In a further configuration of the invention, the data can be read out for service purposes, and when individual parts are exchanged within a machine component 3-8 said data can be stored again in the assigned data memory 10-15, or if appropriate further data can be added thereto.

The setpoint/actual value comparison of the data sets (RFC, LDD, load play limits) used for the configuration of the service life of the component can be used in a suitable way for planning servicing.

Although the invention has been illustrated and described in detail by means of the preferred exemplary embodiment, the invention is not restricted by the disclosed examples and other variants can be derived therefrom by a person skilled in the art without departing from the scope of protection of the invention.

What is claimed is:

1-11. (canceled)

12. A method for configuring and/or putting into operation and/or operating a drivetrain of a machine, comprising:
equipping at least some of non-controllable machine components of the drivetrain with component-specific data memories that store design-related technical data of the non-controllable machine components, which technical data are relevant for a control of one or more of controllable machine components of the drivetrain;
transferring the data stored in the data memories to a control unit; and
controlling one or more of the controllable machine components using the control unit and taking into account the transferred data.

13. The method of claim 12, further comprising equipping at least some of the controllable machine components with component-specific data memories in which at least one parameterization region is stored and has limits within which the corresponding controllable machine component is controllable, transferring the data stored in the data memories of the controllable machine components to the control unit, and controlling the controllable machine components by taking into account said data.

14. The method of claim 12, wherein limiting temperatures and/or limiting rotational speeds and/or limiting power levels and/or moments of inertia and/or spring stiffness values and/or damping constants and/or load dwell time curves (LDD) and/or RFC matrices and/or Campbell diagrams and/or coefficients of safety values of a machine component are stored as design-related technical data in the data memories.

15. The method of claim 12, further comprising detecting actual values of a machine component by at least one sensor, and executing a closed-loop control of at least one controllable machine component by taking into account the actual values detected by the at least one sensor.

16. The method of claim 15, wherein the actual values which are detected by the at least one sensor and technical data stored in the data memories are stored for analysis purposes.

17. The method of claim 16, wherein the actual values are stored for determining an utilization factor of the machine and/or of individual machine components and/or for further processing in a CMS/CDS system.

18. The method of claim 12, further comprising detecting, storing and evaluating a number of times a load of individual machine components is exceeded.

19. The method of claim 12, wherein one of the non-controllable machine components is a transmission.

20. The method of claim 19, further comprising storing in a data memory of the transmission as design-related technical data tooth engagement frequencies and/or rollover frequencies and/or the tooth edge play and/or the rotational tooth edge play.

21. A machine component of a drivetrain, which machine component cannot be controlled by a control unit, said machine component comprising a readable data memory storing design-related technical data of the machine component which are relevant for a control of a controllable machine component of the drivetrain of a machine.

22. The machine component of claim 21, constructed in the form of a transmission, a bearing, a clutch or a brake.

23. The machine component of claim 21, wherein the data memory stores as design-related technical data limiting temperatures and/or limiting rotational speeds and/or limiting power levels and/or moments of inertia and/or spring stiffness values and/or damping constants and/or load dwell time curves (LDD) and/or RFC matrices and/or Campbell diagrams and/or coefficients of safety values of the machine component.
